(19) United States
(12) Patent Application Publication
(10) Pub. No.: US 2015/0012645 A1
(43) Pub. Date: Jan. 8, 2015

(54) COLLECTIVE OVER-THE-TOP APPLICATION POLICY ADMINISTRATION

(71) Applicant: NOKIA SOLUTIONS AND NETWORKS OY, Espoo (FI)

(72) Inventor: John HARRIS, Glenview, IL (US)

(21) Appl. No.: 14/322,714

(22) Filed: Jul. 2, 2014

Related U.S. Application Data
(63) Continuation of application No. PCT/US2013/049449, filed on Jul. 5, 2013.

(51) Int. Cl. H04L 12/26; H04L 29/08

(52) U.S. Cl. CPC H04L 43/00; H04L 67/10
USPC 709/224

(57) ABSTRACT

Various communication systems and devices may benefit from a collective based administration of policies for applications. For example, certain wireless communication systems and devices may benefit from administration of policies related to over-the-top data transmission. A method can include supervising a group of applications. The method can also include monitoring at least one self-optimization of each of a plurality of applications of the group. The method can further include sending a request to at least one of the plurality of applications based on whether the self-optimizations benefit the group as distinct from a respective application.

### CROSS REFERENCE TO RELATED APPLICATION

This is a Continuation of International Patent Application No. PCT/US2013/049449 filed Jul. 5, 2013, which designates the U.S. and was published under PCT Article 21(2) in English. The content of that application is hereby incorporated by reference in its entirety.

### BACKGROUND

1. Field

Various communication systems and devices may benefit from a collective based administration of policies for applications. For example, certain wireless communication systems and devices may benefit from administration of policies related to over-the-top data transmission.

2. Description of the Related Art

Much data traffic in wireless networks may be over-the-top (OTT) data. Thus, it may be difficult, if not impossible, for the network to interpose itself into this process, such that the optimal trade-offs occur across different applications. “Apps” can also be referred to as applications. Existing mechanisms such as using a policy and charging rules function (PCRF), billing-based approaches, and network-based application optimization at the mid-point may be complex or not desirable by those who would need to implement the mechanism(s).

Conventionally, approaches to network management may focus on network-side application servers. For example, an application server in a network may track the location of users and then trigger pre-fetching and/or compression based on the fact that users are near one another and also connected to this application server.

Moreover, conventionally if a first application or device reduces or avoids resource use, then a second application or device in that cell will typically get greater resources. In this context, there is no conventional application based mechanism for rewarding/punishing applications depending on their degree of cooperation and compliance with requests for cooperation.

Moreover, it may be expensive and/or cumbersome for a network to interpose itself at the application layer and to determine or set a degree of compliance so that applications are properly incentivized to work around network limitations for the system of applications.

### SUMMARY

According to certain embodiments, a method can include supervising a group of applications. The method can also include monitoring at least one self-optimization of each of a plurality of applications of the group. The method can further include sending a self-optimization request to at least one of the plurality of applications based on whether the self-optimizations benefit the group as distinct from a respective application.

In certain embodiments, an apparatus can include at least one processor and at least one memory including computer program instructions. The at least one memory and the computer program instructions can be configured to, with the at least one processor, cause the apparatus at least to supervise a group of applications. The at least one memory and the computer program instructions can also be configured to, with the at least one processor, cause the apparatus at least to monitor at least one self-optimization of each of a plurality of applications of the group. The at least one memory and the computer program instructions can further be configured to, with the at least one processor, cause the apparatus at least to send a self-optimization request to at least one of the plurality of applications based on whether the self-optimizations benefit the group as distinct from a respective application.

An apparatus, according to certain embodiments, can include means for supervising a group of applications. The apparatus can also include means for monitoring at least one self-optimization of each of a plurality of applications of the group. The apparatus can further include means for sending a self-optimization request to at least one of the plurality of applications based on whether the self-optimizations benefit the group as distinct from a respective application.

A computer program product, in certain embodiments, is encoded with instructions to perform a process. The process can include supervising a group of applications. The process can also include monitoring at least one self-optimization of each of a plurality of applications of the group. The process can further include sending a self-optimization request to at least one of the plurality of applications based on whether the self-optimizations benefit the group as distinct from a respective application.

A non-transitory computer-readable medium can, in certain embodiments, be encoded with instructions that, when executed in hardware, perform a process. The process can include supervising a group of applications. The process can also include monitoring at least one self-optimization of each of a plurality of applications of the group. The process can further include sending a self-optimization request to at least one of the plurality of applications based on whether the self-optimizations benefit the group as distinct from a respective application.

According to certain embodiments, a chipset can be configured at least to supervise a group of applications. The chipset can also be configured to monitor at least one self-optimization of each of a plurality of applications of the group. The chipset can further be configured to send a self-optimization request to at least one of the plurality of applications based on whether the self-optimizations benefit the group as distinct from a respective application.

### BRIEF DESCRIPTION OF THE DRAWINGS

For proper understanding of the invention, reference should be made to the accompanying drawings, wherein:

FIG. 1 illustrates a flowchart of a method according to certain embodiments.

FIG. 2 illustrates a signal flow according to certain embodiments.

FIG. 3 illustrates a method according to certain embodiments.

FIG. 4 illustrates a system according to certain embodiments.

### DETAILED DESCRIPTION

Various techniques for administering policies for devices and applications on device can be employed. For example, a knowledge server may serve networking insights to applications, so that they can better work around network limitations. Moreover, in certain embodiments additional incentives can encourage applications to work around network limitations in a cooperative way. An incentive structure, as described below, may include specific metrics for measuring degrees of compliance of each application. Additionally, compliance scores might (accumulated or shared) be calculated across a number of different levels within the overall population of devices, Apps and users. For example, a compliance score specific to a streaming video service might be calculated, across all users of the service, even across different operating systems, regardless of whether they are running on competing operating systems. The high compliance score for the streaming video service may earn a new user of an app for the streaming video service the same benefits as an existing user of the same app.

In another example compliance scores might be calculated on a per device type basis. For example, a compliance score of a first operating system can be compared to compliance of all other operating systems or each other operating system. In another example compliance scores might be calculated on a per UE device vendor basis. For example, a device compliance score of a first manufacturer can be compared to a compliance score of a second manufacturer. In another example a compliance score can be calculated on a per user basis. For example, a first user can have a different compliance score than a second user. In a per-user basis embodiment, the complaint score may follow the user across multiple devices used by the user. For example, multiple devices may be linked by a subscriber identification number.

In yet another example, an entire enterprise or social group may earn an overall compliance score for their overall group of users. This may then enable lower tier (entry-level) users within the enterprise to be more compliant, such that higher/ranking users within the enterprise can be less compliant and yet still benefit from being a part of the overall relatively compliant enterprise or organization.

In another example compliance scores can be calculated on a per device basis.

Furthermore, the incentive structure can include mechanisms whereby the applications can help to self-police, reward, and/or punish applications depending on a level of compliance to the needs of a larger group of applications. Thus, this can avoid a purely top-down structure in which evolved Node B (eNB) radio control of quality of service (QoS) is the only mechanism by which applications use of resources is limited.

Conventionally, there is no application based framework for incentivizing and rewarding applications that perform such adaptations, without any complicated coupling with the network. Such applications within such an application supervision collective may permit better overall user experience and better overall network usage.

By contrast, certain embodiments may provide an application collective of self-policing collective of applications. For example, certain embodiments provide for a collective of applications on a single user equipment (UE), administrated by a UE operating system. The operating system or another application may monitor compliance levels and then automatically reward or punish applications that are more or less compliant to the needs of the overall application collective. This reward and/or punishment policing function can operate such that the collective is more responsive to a relief request from or for more compliant applications and less responsive to requests from or for less compliant applications.

Certain embodiments may provide a prioritization of helping other applications in the collective, as opposed to those which are out of the collective. In certain embodiments, applications in the collective may be the only ones that receive accommodations from the collective in terms of adaptations to data usage behavior.

Collective compliance scoring across applications can, in certain embodiments, be provided by collective monitoring function. For example, the collective monitoring function can monitor a degree of compliance by different applications, in terms of how responsive each application is to adapting the application's behaviors in response to anticipated network bottlenecks. Moreover, the collective monitoring function can provide a greater service quality boost for users and/or applications which have higher compliance scores.

The messaging between applications and the collective supervising function can provide the incentive for applications to adapt for the greater collective good. This messaging can be internal within a user equipment device or can be external to an external collective monitoring function device.

Prioritization of helping other applications in the collective, and not those which are out of the collective can take on different forms. For example, modification of navigation routes within a mobile navigation application can disproportionately avoid passing through congested regions where larger number of users in the collective are not meeting their application requirements, but can allow the user to take the shortest route when that passes through congested regions which do not inconvenience other users within the application collective.

Certain embodiments may also include messaging by, or in order to create, a collective of separate application providers. These applications or application providers may have limited or no trust of one another. Thus, external metrics can be used to supervise the degree to which each application collective is performing adaptations which help the collective.

More specifically, certain embodiments can accomplish a condition in which a reward for compliance is provided not by having the radio infrastructure boost that application's priority, but instead by the other applications in the collective reducing their usage. Thus, the collective can detect that the application is a “good” and/or compliant application in that it avoids harming the experience of the other applications in the collective.

Thus, certain embodiments may improve customer experience when different applications cooperate. In general, OTT wireless data users in a same cell may be sharing, somewhat selfishly, a finite amount of radio frequency (RF) resources. Moreover, these applications may be provided by a number of different application developers. Thus, certain embodiments provide an application based framework for incentivizing and rewarding applications that perform cooperative adaptations, without requiring complex coupling with the network.

More specifically, certain embodiments provide an application based mechanism for rewarding/punishing applications depending on their degree of cooperation or compliance. A supervision entity to provide this mechanism may reside within a UE operating system. Alternatively, the supervision entity may reside external to the user equipment, such as in a base station of a cell or in a core network entity.

Certain embodiments provide a method of creating a group of participating applications, which may be referred to as the collective, and supervising the degree to which each application within the collection of wireless applications self optimizes in order to benefit the overall collection of applications. This supervising may involve grading and/or monitoring a degree of compliance. The method can also include instructing the collective of applications to be even more compliant to the needs of applications with higher compliance scores.

A system implanting this method may include an application collective compliance monitoring and reward entity. This collective compliance entity can communicate with a first group of participating applications, which may be the collective. In response to an indication of insufficient resources that required for a first application, the compliance entity can transmit application adaptation request(s) to at least one other application in the first group of applications requesting that the receiving application perform in adaptation. The compliance entity can then monitor the degree to which the at least one application receiving the request adapts. For example, the degree to which the application reduces usage in problem locations and times. This monitoring and compliance may be done in order to benefit the overall collection of applications.

The compliance entity's transmission of an application adaptation request can be performed, in certain embodiments, only if the adaptation request corresponds to an application with greater than a threshold compliance score. Alternatively, the basis can be whether the application has a compliance score of at least a threshold amount.

The collective compliance entity can reside within a UE operating system and can perform the above-described method across the applications residing on that same UE device. Alternatively, the collective compliance entity may be external to the UE.

The compliance entity can receive a request for help or distress (SOS) message from or for a specific application i. This message can be triggered based on a detected or anticipated network loading resulting in quality of service (QoS) being insufficient for application i's requirements. The application i may anticipate the need to transmit an SOS in response to network limitations insights provided by a knowledge server. Moreover, the compliance entity can receives a help/SOS request from a network element coupled to a part of the radio access network.

Moreover, when the collective compliance entity receives a help/SOS request from a specific application i, the collective compliance entity can check whether the compliance score for application i is greater than a predetermined threshold. If the score is greater than the threshold, the collective compliance entity can forward the SOS request to at least one application in the collective of applications. Additionally, the entity can ignores or forward fewer requests from applications with lower compliance scores. For example, the entity can pseudo-randomly forward only half the requests from applications with lower compliance scores.

The collective compliance entity can also perform a selection of which applications should receive a forwarded SOS/help request. This selection may be based on which applications appear to be in a position to provide the greatest relief to the network limitations impacting the collective. Alternatively, or in addition, the selection may be based on the applications' compliance scores. For example, the collective compliance entity may disproportionately instruct applications with lower compliance scores to perform more adaptations, such as usage reductions, when needed by other applications within the collective with higher compliance scores. Thus, the collective compliance entity may help the lower scoring applications to be even more compliant to the needs of applications with higher compliance scores, within the first group of applications.

The compliance entity can monitor for the degree of compliance to instructions by a process that includes assigning a higher or better compliance score if an application works around network limitations. For example, the score may be increased or improved if the application complies with larger percentage of the entities requests or if pre-fetch is larger fraction of bytes when requested. Consideration can include usage of pre-fetching during network idling, avoiding coverage gaps, avoiding extra loading for problem locations, and using few SOS requests. Likewise, the score may be increased or improved if pre-fetch is larger fraction of the total bytes that are consumed. This measure may be a relative measure taking into account other applications in the same application class. Another score factor may be whether the application requests a lower priority when pre-fetching, instead of attempting to pre-fetch using normal or higher priority. A further score factor may be whether the application has a higher return on investment (ROI) for pre-fetched data. For example, the percentage of bytes that are pre-fetched that are actually used by the user may correspond to the ROI, and a high ROI may yield a higher score.

There can be many other score factors. For example, a score factor can be whether an application leads the user to use alternate routes to navigate around problem/loaded areas for other applications.

In certain embodiments, the collective compliance entity can reside within a network server, an application store, a marketplace, or another server. The collective compliance entity can collect compliance statistics from UE operating systems, a compliance supervision App and/or applications themselves. This may be accomplished in various ways. For example, this may be accomplished through a collective compliance management system. This may be similar to the case of multiple applications on a single UE device, except instead of having messaging between the applications and the device's own operating system, the messaging may be between the application/devices and the collective server. In the case of a compliance supervision App, for example using a given operating system, applications on a given device would communicate between the application and the compliance supervision app. The compliance supervision app can provide functionality similar to that described for the operating system embodiment, except that the compliance supervision functionality can be installed onto the device as an App that is separate from the given operating system.

Additionally, this compliance supervision mechanism can be used to create cooperation across apps running on different devices where those devices for example occupy the same cell. In yet another example, compliance may great impact in scenarios across cells. For example, when a user of streaming video service is in cell X and is compliant to a request, that compliance can earn a compliance score credit that enables a benefit for a different user of the same video streaming service, even if the user is currently in a completely different portion of the system under a different cell.

In another embodiment, an individual user may have the ability to control the degree to which the user's device and/or Apps will be cooperative/compliant to the needs of a larger collective of apps. For example this degree of cooperation or compliance may be controlled within the settings of the device itself Furthermore the user may specify that the collective to which the user wishes to be compliant corresponds only to, for example, the user's social network. This collective, therefore, may be based on friends established within a social networking site. In this embodiment, the user may be compliant in response to requests received from others explicitly within their n^{th} order social network. As a further incentive, such users' compliance score(s) can be displayed as part of their profile on each social network site, creating a further social incentive to work together.

In another embodiment, the degree of compliance of an App or device can be automatically adjusted based upon constraints such as lower UE battery life, user's meeting schedules, or the like. Thus, compliance or cooperation can be reduced where complying would cause higher inconvenience/degradation for that user.

In other embodiments, the collective compliance entity can use peer to peer mechanisms for coordinating across large groups of devices. Moreover, the collective compliance entity can selectively use peer-to-peer communication.

The collective compliance entity, which may be an operating system or an external entity, as mentioned above, can send a request message. This request message can include an indicator to each application. The indicator can indicate times and/or locations where the collective is seeking to reduce the amount of unnecessary traffic. Alternatively, or in addition, the indicator can indicate the percentage depth of pre-fetching and a corresponding timescale. For example, if the indicator indicates X% pre-fetch over the next 8 hours, then the application should pre-fetch enough traffic, such that ˜X% of the traffic pre-fetched is expected to be consumed by the device user over the relevant time period.

In view of such an incentive, the UE device operating system (OS) may be able to increase the percentage X when it anticipates that the device would otherwise normally be fetching significant amounts of traffic in the same cell as many other collective applications and/or devices, which are unable to meet their applications requirements.

Furthermore, the application programming interface (API) may request that the application provide feedback on this the fraction of pre-fetch traffic which was actually consumed by the user.

Alternatively, the UE operating system could take on the role of tracking the percentage of pre-fetched traffic for that particular application which is eventually consumed by the user. In this case, the API can command the application to perform a certain number of megabytes of pre-fetching, and then to later report back to the OS what fraction of the pre-fetch traffic was consumed.

In certain embodiments, applications that provide better congestion avoidance will then be rewarded by receiving a larger fraction of the bandwidth allocated to the UE, with less delay, than other applications on the device.

Thus, certain embodiments can provide for the dynamic management of the fraction of wireless resources granted to the device, among the applications submitted traffic for delivery over the wireless link.

The compliance entity can perform other actions. For example, the compliance entity can send a second round of requests if it receives insufficient acceptance or confirmation replies indicating that the SOS or help request has been satisfied. Additional rounds of request are also permitted. The scope of these requests may be different from one another. For example, a first request may be narrowly directed to one or a few applications, whereas second or subsequent requests may be directed to many or all applications. Additionally, it may be that the collective compliance indication includes an indication of the relative amount of compliance score boost which can be achieved by complying with a specific request. In this case, the second round request could then potentially convey a greater compliance score boost. The user could also be therefore conveyed to some the same apps which declined to comply in response to the 1^{st} compliance request.

The compliance entity can also report to applications regarding their current compliance score. For example, the compliance entity can send the score to the applications. Moreover, applications can band together to agree to cooperate across applications in the same cell based on certain best practices or rules of engagement that will improve the experience of all applications within the collective. Applications not within the collective may consequently be less competitive.

For example, when a larger number of applications in the collective are anticipated to be or currently are suffering lower throughput while meeting higher bit rate services in the same cell, then other applications within the collective may automatically perform greater pre-fetching in advance in order to reduce congestion. The other applications may also perform greater throttling of other relatively low priority OTT services while in the congested cell. Furthermore, certain applications may perform navigation route modification.

Collective compliance scoring across applications by collective monitoring function within a single UE is also possible in certain embodiments. The compliance entity can encourage greater resource efficiency by each application on the UE device by having the device OS maintain metrics on congestion avoidance best practices on a per application basis. For example, applications that provide better congestion avoidance best practice adherence can receive a larger fraction of the bandwidth allocated the UE, optionally with less delay, than other applications on the device.

A first example of encouraging cooperative behavior may be encouraging greater pre-fetching by a first application on the device when it is anticipated that a second application will need to perform a real-time service in an upcoming throughput limited cell or environment.

A benefit in this case is that there may be more proactive avoidance of first application needing to fetch traffic while a second application is simultaneously performing a higher bit rate real-time service. Normally the first application would not need to pre-fetch as much, but because of the anticipated needs of the second application and expected corresponding network throughput, it may be more appropriate to pre-fetch for the first application in order to reduce the likelihood that both applications will need to retrieve simultaneously.

A second example of encouraging cooperative behavior may be encouraging greater compression by a first application on the device when a second application on that device needs to perform a real-time service in an upcoming throughput limited cell or environment. For example, this can be achieved by the UE device OS performing throttling on the fraction of RF resources allocated to the UE which are used to schedule the traffic from the first application as opposed to the second application.

Certain embodiments may provide for collective compliance scoring across applications by collective monitoring function, such as by an application store and/or a UE operating system, across different devices or applications in the same cell, which applications/devices are in the collective. It may be in the collective's self-interest to reduce congestion for its own devices, in cases where more of its own devices will likely benefit.

A third example of encouraging cooperative behavior may be encouraging greater pre-fetching by the collective's devices which are anticipated to be soon in a cell, which will be very congested with any other of the collective's devices. If there is a single collective member device expected to be in a cell congested with users of a same operating system, and the collective member user is not expected to need any high bit rate, wireless services that cell, then it is less important for that single collective member to perform pre-fetching.

Certain embodiments may involve modifying navigation in mapping applications based upon communication requirements of other applications or users in the collective. A user of a navigation application, user X, may be generating some moderate amount of media bit rate traffic, and may be about to drive through a cell that is congested with users of the same operating system, which users are dissatisfied or require very high bit rates or low delay.

Normally, user X would not need to modify the route, because the throughput anticipated in that congested cell is not sufficient to impact user X's own wireless experience. In certain embodiments, however, because selecting the route may greatly influence a significantly large number of other users of the same operating system in that cell, the navigation application may automatically modify user X's route.

By contrast, in certain embodiments if the cell which is congested is populated only or mainly with dissatisfied users of other operating systems or with low priority users of the same operating system, then the navigation application user does not need to modify the route to avoid the cell.

Thus, there may be a value add for applications in the collective in that the applications and developers can take a more global view of the customer base and doing the right thing, while not adapting their traffic in order to improve the customer experience of non-collective applications.

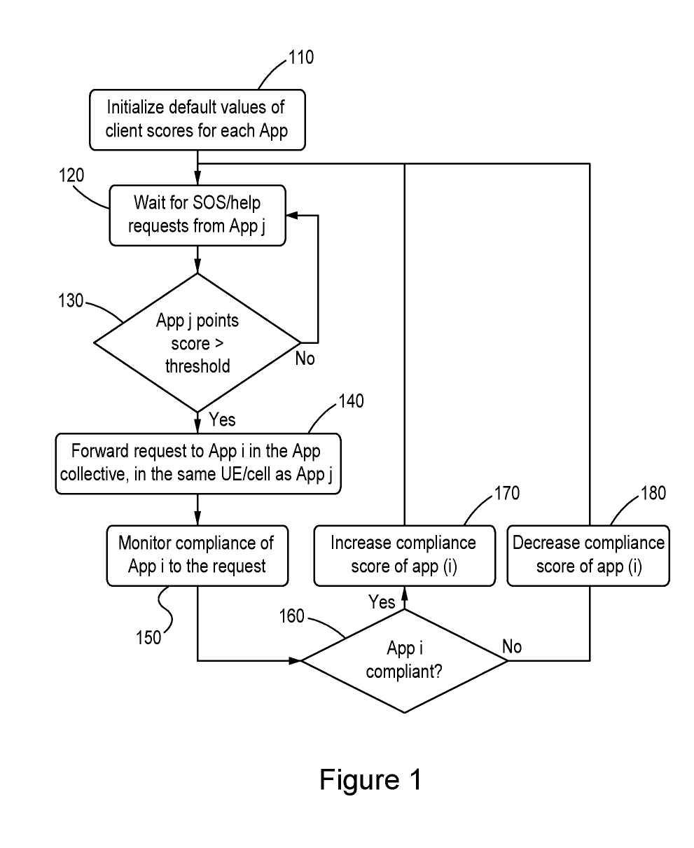

FIG. 1 illustrates a flowchart of a method according to certain embodiments. As shown in FIG. 1, a method can include, at 110, initializing default values of client scores for each application (App). The method can also include, at 120, waiting for an SOS or help request from any application j. When such a request is received from application j, a determination can be made at 130 as to whether application j has points score above a threshold. If not, the waiting can continue at 120. If the points do exceed a threshold, then at 140 the request can be forwarded to application i, in the application collective. This application may be in the same user equipment or in the same cell as the instance of application j that is requesting help.

The system can, at 150, monitor compliance of application i with the request. A determination can be made at 160 about whether application i has complied. If so, a compliance score for application i can be increased at 170. Otherwise, at 180 the compliance score can be decreased. In either case, the process can return to waiting at 120.

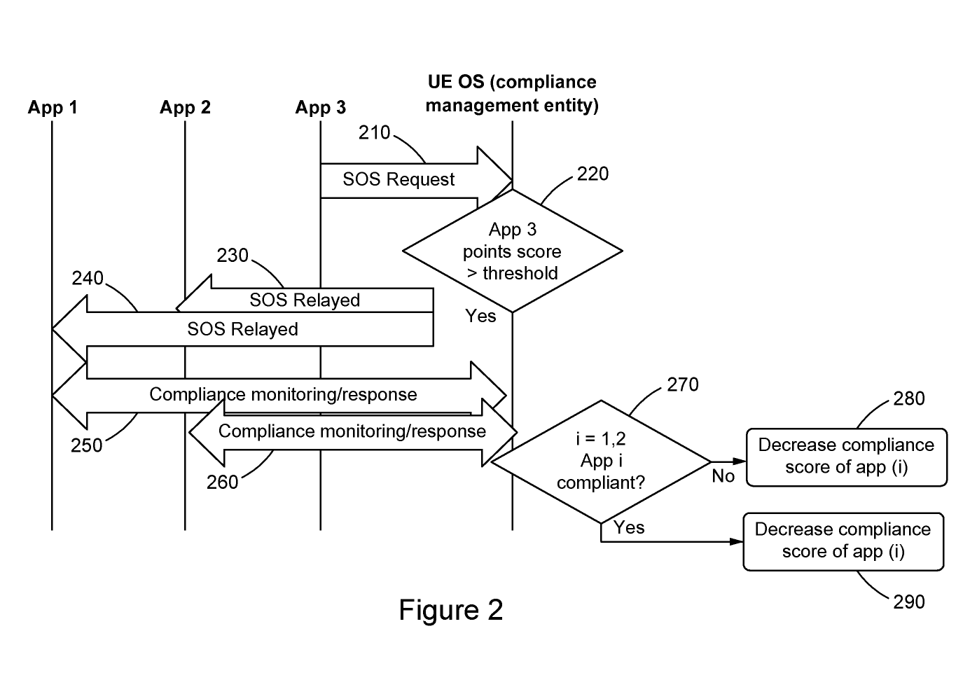

FIG. 2 illustrates a signal flow according to certain embodiments. As shown in FIG. 2, at 210 application (App) 3 can send an SOS request to the UE OS or another compliance management entity. At 220, the UE OS or other compliance management entity can determine that application 3 has a compliance points score that is greater than a predetermined threshold. Therefore, at 230 the UE OS or other compliance management entity can relay the SOS to application 2, and at 240 the UE OS or other compliance management entity can relay the SOS to application 1. These can be sent individually or as a broadcast message.

At 250, the UE OS or other compliance management entity can monitor compliance and/or wait for and receive a response from application 1. Likewise, at 260 the UE OS or other compliance management entity can monitor compliance and/or wait for and receive a response from application 2. Then, at 270, for each application—in this case application 1 and application 2—the UE OS or other compliance management entity can determine whether the application is compliant at 270. The UE OS or other compliance management entity can either, at 280, decrease the compliance score if the application is not compliant or, at 290, increase the compliance score if the application is compliant.

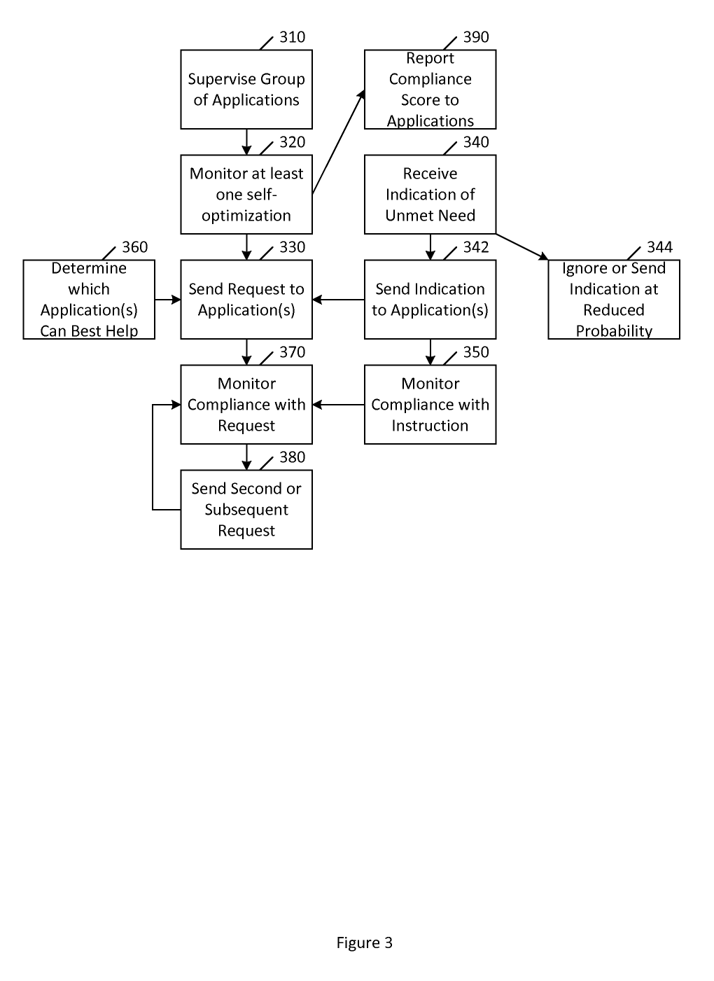

FIG. 3 illustrates a method according to certain embodiments. As shown in FIG. 3, a method can include, at 310, supervising a group of applications. The method can be performed by a user equipment on which the group of applications resides. Alternatively, the method can be performed by a network element or a peer node, as mentioned above. For example, the method can be performed by a collective compliance entity on a server remote from a user equipment on which the group of applications resides.

The method can also include, at 320, monitoring at least one self-optimization of each of a plurality of applications of the group. The method can further include, at 330, sending a request to at least one of the plurality of applications based on whether the self-optimizations benefit the group as distinct from a respective application.

The request can be configured to indicate at least one of time at which to reduce amount of unnecessary traffic, location at which to reduce amount of unnecessary traffic, or percentage depth of prefetching For example, the request can be or include a request to navigate to avoid a geographic area.

The method can additionally, include, at 340, receiving an indication regarding a first application of the group of applications that a resource requirement for the first application is unmet. Moreover, the method can include, at 342, sending an instruction to at least one application of the group to adapt based on the indication. This may be or involve sending the request at 330. This instruction may be non-compulsory and may be referred to as a request.

In other words, the sending can involve sending a self-optimization request to at least one of the plurality of applications based on whether the self-optimizations requested and monitored benefit the group as distinct from a respective application. Thus, the request can be based on whether the self-optimizations benefit the group as distinct from a respective application because.

The request may indicate the compliance score benefit/model and may be based on whether the self-optimizations benefit the group as distinct from a respective application. Moreover, the sending of the request may be done in a way that is based on whether the self-optimizations requested and monitored benefited the group as distinct from a respective application. For example, requests in general, or more requests, can be sent on behalf of Apps which are known to be compliant. Alternatively, the method can involve sending requests in general, or more requests, to Apps which have not yet shown as much compliance, and consequently may need to show or earn compliance ratings. Other variations are also permitted.

The messaging of the request can be performed at the OTT layer, as opposed to being transmitted by PCRF signaling or radio signaling.

Furthermore, the method can include, at 350, monitoring compliance of each of the plurality of applications with respect to the instruction.

The instruction can further be based on a compliance score of the first application. The compliance score can be related to cooperative behavior amongst applications.

The instruction can be conditional on the compliance score of the first application exceeding a predetermined threshold. The compliance score can be based on at least one of following requests related to compliance, utilization of prefetching as a fraction of data usage, actual usage fraction of requested data, or avoidance of congested areas. Other score factors are also permitted, as discussed above.

The method can also include, at 344, ignoring, or forwarding with a reduced probability, the indication when the first application has a compliance score below a predetermined threshold, wherein the compliance score is related to cooperative behavior amongst applications.

The method can further include, at 360, determining which at least one application is configured to provide a greatest relief to a network limitation experienced by the group, wherein the instructing is directed to the at least one application that is configured to provide the greatest relief. For example, an application which is currently transferring a large volume of traffic and generating a large amount of RF resource consumption under the same cell (and possibly even inside the same UE) can be said to be “configured” to provide the greatest relief.

Additionally, the compliance manager can check whether adaptation of any other App could possibly provide any relief. If the answer is no, then there may be no need to generate a request to any such application. An example would be where an App makes a request, but there is no other App currently transferring traffic in the same cell which is competing with the traffic from the requesting App. The system can further leverage knowledge of current network limitations, such as whether or not this particular case reducing the volume transfer from existing users in that region will benefit the user making the request. For example, an application X may not be receiving the communication speed it requires, but causing others to reduce their usage or modify notification may not benefit application X, because of, for example, power limitations, application server bottlenecks, or other scenarios.

The method can additionally include, at 370, monitoring whether the at least one of the plurality of applications has followed the request. The method can also include, at 380, sending a second request when it is determined that the request was insufficiently followed. Subsequent requests are also permitted, as mentioned above.

The method can also include, at 390, reporting to a plurality of applications of the group a respective compliance score, wherein the compliance score is related to cooperative behavior amongst applications.

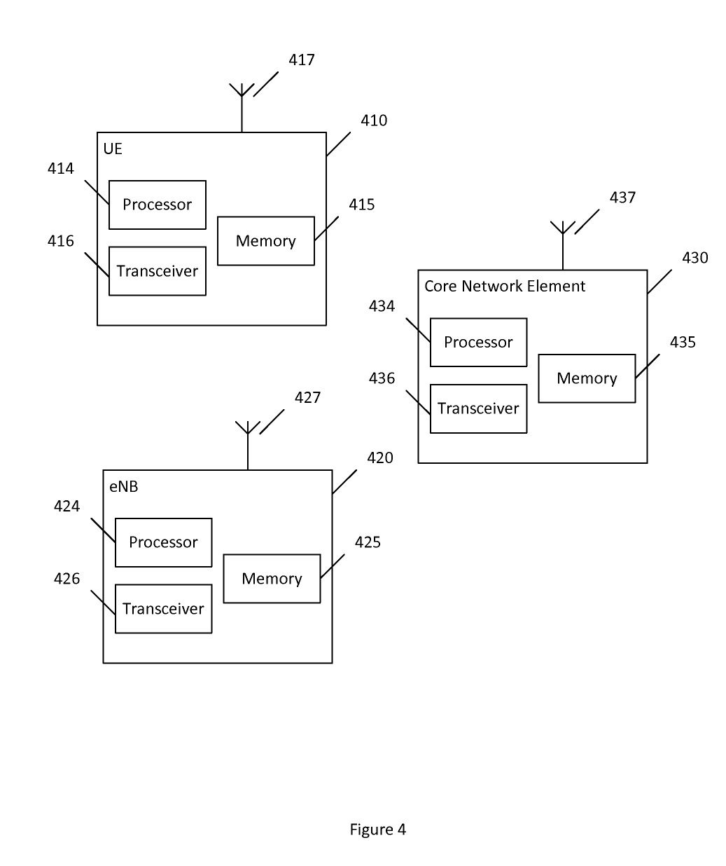

FIG. 4 illustrates a system according to certain embodiments of the invention. In one embodiment, a system may include multiple devices, such as, for example, at least one UE 410, at least one eNB 420 or other base station or access point, and at least one core network element 430. In certain systems, only UE 410 may be present, and in other systems UE 410, eNB 420, and a plurality of other user equipment may be present. Other configurations are also possible.

Each of these devices may include at least one processor, respectively indicated as 414, 424, and 434. At least one memory can be provided in each device, and indicated as 415, 425, and 435, respectively. The memory may include computer program instructions or computer code contained therein. The processors 414, 424, and 434 and memories 415, 425, and 435 can be configured to provide means corresponding to the various blocks of FIG. 3.

As shown in FIG. 4, transceivers 416, 426, and 436 can be provided, and each device may also include an antenna, respectively illustrated as 417, 427, and 437. Other configurations of these devices, for example, may be provided. For example, core network element 430 may be configured for wired communication, rather than wireless communication, and in such a case antenna 437 would illustrate any form of communication hardware, without requiring a conventional antenna.

Transceivers 416, 426, and 436 can each, independently, be a transmitter, a receiver, or both a transmitter and a receiver, or a unit or device that is configured both for transmission and reception.

Processors 414, 424, and 434 can be embodied by any computational or data processing device, such as a central processing unit (CPU), application specific integrated circuit (ASIC), or comparable device. The processors can be implemented as a single controller, or a plurality of controllers or processors.

Memories 415, 425, and 435 can independently be any suitable storage device, such as a non-transitory computer-readable medium. A hard disk drive (HDD), random access memory (RAM), flash memory, or other suitable memory can be used. The memories can be combined on a single integrated circuit as the processor, or may be separate from the one or more processors. Furthermore, the computer program instructions stored in the memory and which may be processed by the processors can be any suitable form of computer program code, for example, a compiled or interpreted computer program written in any suitable programming language.

The memory and the computer program instructions can be configured, with the processor for the particular device, to cause a hardware apparatus such as UE 410, eNB 420, and core network element 430, to perform any of the processes described above (see, for example, FIGS. 1-3). Therefore, in certain embodiments, a non-transitory computer-readable medium can be encoded with computer instructions that, when executed in hardware, perform a process such as one of the processes described herein. Alternatively, certain embodiments of the invention can be performed entirely in hardware.

Furthermore, although FIG. 4 illustrates a system including a UE, eNB, and core network element, embodiments of the invention may be applicable to other configurations, and configurations involving additional elements, as illustrated herein, for example in FIG. 2. For example, any of the devices of the system of FIG. 4 can individually or cooperatively be configured as a compliance monitoring function or a compliance monitoring entity.

Various benefits and advantages may arise from certain embodiments. For example, certain embodiments may be able to enhance a knowledge server that is configured to serve insights to applications. Moreover, certain embodiments may provide an incentive for individual applications to be smart and/or adaptive about working around network limitations in order to benefit a broader group of applications, such as within a larger collection of applications, namely a collective of applications.

Moreover, certain embodiments may serve to encourage greater resource efficiency by each application on the UE device by having the device OS maintain metrics on congestion avoidance best practices on a per application basis. Applications that provide better congestion avoidance best practice adherence may receive a larger fraction of the bandwidth allocated to the UE, with less delay, than other applications on the device.

UE applications' control points cooperating may enable UE applications to do various things. For example, such cooperation may permit UE applications to avoid congestion and video gaps, work around network limitations, and utilize more free/idle resources. Moreover, such cooperation may be able to boost network utilization and bit rates while reducing video freezes and call drops.

The approach of certain embodiments may be beneficial in that the approach may create value for collectives of application providers that band together, while not requiring any external cooperation from the network. Thus, certain embodiments may be able to work regardless of the network gear provider. Moreover, certain embodiments may work for both cellular and Wi-Fi. Further, certain embodiments may be beneficial for the communication service provider (CSP) and for the network gear vendor in that certain embodiments may improve the customer experience, boost network utilization, reduce call drops, and further incentivize applications and UE operating system providers to work around network limitations.

Moreover, in cases where embodiments are implemented in the user equipment, the network gear provider may not need to make significant modifications to the network gear. However, certain networks could provide input, such as where a knowledge server, which may be network gear, can serve network insights to applications which query the network using, for example, a hyper-text transfer protocol (HTTP) request.

Thus, the network can provide greater guidance on when wireless resources are being wasted and/or expected to be congested. The mechanisms described above may heighten motivation for applications to perform wireless resource efficient adaptations in response, for example, to knowledge server insights.

Likewise, crowd sources may provide some network insights, such as likely areas of poor coverage. These insights can be provided to an API for applications to incorporate this information into their application design. Certain embodiments, however, can provide an entire cross-application incentivizing framework, for use by collectives of applications and for use by UE OS device manufacturers.

Moreover, certain embodiments may encourage greater pre-fetching by a first application on the device when it anticipates that a second application will need to perform a real-time service in an upcoming throughput limited cell/environment. The benefit in this case may include more proactive avoidance of a first application needing to fetch traffic while the second application is simultaneously performing a higher bit rate real-time service. Normally the first application would not need to pre-fetch as much. Nevertheless, because of the anticipated needs of the second application and expected corresponding network throughput, it may be more appropriate to pre-fetch for the first application in order to reduce the likelihood that both applications will need to retrieve simultaneously, as mentioned above.

With authorized shared access (ASA) and continuing bursty user traffic patterns, a large amount of idle resources may be present. Certain embodiments may permit applications collectively to take advantage of the no idle resources, thereby more evenly spreading traffic and reducing burstiness.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A method, comprising:
supervising a group of applications;
monitoring at least one self-optimization of each of a plurality of applications of the group; and
sending a self-optimization request to at least one of the plurality of applications based on whether self-optimizations benefit the group as distinct from a respective application.

2. The method of claim 1, further comprising:
receiving an indication regarding a first application of the group of applications that a resource requirement for the first application is unmet; and
sending a request to at least one application of the group to adapt based on the indication.

3. The method of claim 2, wherein messaging of the request is performed at an over the top layer.

4. The method of claim 2, further comprising:
monitoring compliance of each of the plurality of applications with respect to the request.

5. The method of claim 2, wherein the request is further based on a compliance score of the first application, wherein the compliance score is related to cooperative behavior amongst applications.

6. The method of claim 5, wherein the request is conditional on the compliance score of the first application exceeding a predetermined threshold.

7. The method of claim 5, wherein the compliance score is based on at least one of following requests related to compliance, utilization of prefetching as a fraction of data usage, actual usage fraction of requested data, or avoidance of congested areas.

8. The method of claim 1, wherein the method is performed by a user equipment on which the group of applications resides.

9. The method of claim 1, further comprising:
receiving an indication regarding a first application of the group of applications that a resource requirement for the first application is unmet; and
ignoring, or forwarding with a reduced probability, the indication when the first application has a compliance score below a predetermined threshold, wherein the compliance score is related to cooperative behavior amongst applications.

10. The method of claim 1, further comprising:
determining which at least one application is configured to provide a greatest relief to a network limitation experienced by the group, wherein the instructing is directed to the at least one application that is configured to provide the greatest relief

11. The method of claim 1, wherein the method is performed by a collective compliance entity on a server remote from a user equipment on which the group of applications resides.

12. The method of claim 1, wherein the self optimization request is configured to indicate at least one of time at which to reduce amount of unnecessary traffic, location at which to reduce amount of unnecessary traffic, or percentage depth of prefetching.

13. The method of claim 1, further comprising:
monitoring whether the at least one of the plurality of applications has followed the request; and
sending a second request when it is determined that the request was insufficiently followed.

14. The method of claim 1, further comprising:
reporting to a plurality of applications of the group a respective compliance score, wherein the compliance score is related to cooperative behavior amongst applications.

15. The method of claim 1, wherein the self-optimization request comprises a request to navigate to avoid a geographic area.

16. The method of claim 1, further comprising:
determining whether a first application is using a real-time service; and
proactively prefetching for a second application based on a determination that the first application is using the real-time service.

17. An apparatus, comprising:
at least one processor; and
at least one memory including computer program instructions,
wherein the at least one memory and the computer program instructions are configured to, with the at least one processor, cause the apparatus at least to
supervise a group of applications;
monitor at least one self-optimization of each of a plurality of applications of the group; and
send a self-optimization request to at least one of the plurality of applications based on whether the self-optimizations benefit the group as distinct from a respective application.

18. The apparatus of claim 17, wherein the at least one memory and the computer program instructions are configured to, with the at least one processor, cause the apparatus at least to:
receive an indication regarding a first application of the group of applications that a resource requirement for the first application is unmet; and
send a request to at least one application of the group to adapt based on the indication.

19. The apparatus of claim 17, wherein the at least one memory and the computer program instructions are configured to, with the at least one processor, cause the apparatus at least to:
monitor whether the at least one of the plurality of applications has followed the request; and
send a second request when it is determined that the request was insufficiently followed.

20. A chipset, wherein the chipset is configured at least to
supervise a group of applications;
monitor at least one self-optimization of each of a plurality of applications of the group; and
send a self-optimization request to at least one of the plurality of applications based on whether the self-optimizations benefit the group as distinct from a respective application.
